(19) United States
(12) Patent Application Publication
(10) Pub. No.: US 2026/0057075 A1
(43) Pub. Date: Feb. 26, 2026

(54) ON-DEVICE ATTESTATION SERVICE

(71) Applicant: Samsung Electronics Co., Ltd., Suwon-si (KR)

(72) Inventor: Mohammad Mahbubul Alam Miazi, Folsom, CA (US)

(21) Appl. No.: 19/078,063

(22) Filed: Mar. 12, 2025

Related U.S. Application Data
(60) Provisional application No. 63/647,517, filed on May 14, 2024.

(51) Int. Cl. G06F 21/57; G06F 21/55; G06F 40/205

(52) U.S. Cl. CPC G06F 21/575; G06F 21/554; G06F 40/205

(57) ABSTRACT

A method includes performing attestation of an electronic device. Performing the attestation includes retrieving preset security measurements stored in secure storage of a secure embedded controller of the electronic device. Performing the attestation also includes retrieving current firmware component measurements from platform configuration registers (PCRs) of a trusted platform module (TPM) of the electronic device. Performing the attestation includes comparing the preset security measurements with the current firmware component measurements. Performing the attestation includes approving or denying the attestation based on the comparison of the preset security measurements with the current firmware component measurements.

### CROSS-REFERENCE TO RELATED APPLICATION AND PRIORITY CLAIM

This application claims priority under 35 U.S.C. § 119(e) to U.S. Provisional Patent Application No. 63/647,517 filed on May 14, 2024, which is hereby incorporated by reference in its entirety.

### TECHNICAL FIELD

This disclosure generally relates to electronic device security. More specifically, this disclosure relates to an on-device attestation service.

### BACKGROUND

With the increasing number of cyber attacks, it is essential to ensure an electronic device is booted without any evidence of tampering. Attestation is one of the processes through which an electronic device’s health can be verified using one or more reference measurements. However, existing attestation techniques have various issues.

### SUMMARY

This disclosure relates to an on-device attestation service.

In a first embodiment, a method includes performing attestation of an electronic device. Performing the attestation includes retrieving preset security measurements stored in secure storage of a secure embedded controller of the electronic device. Performing the attestation also includes retrieving current firmware component measurements from platform configuration registers (PCRs) of a trusted platform module (TPM) of the electronic device. Performing the attestation includes comparing the preset security measurements with the current firmware component measurements. Performing the attestation includes approving or denying the attestation based on the comparison of the preset security measurements with the current firmware component measurements.

In a second embodiment, an electronic device includes at least one processing device configured to perform attestation of the electronic device. To perform the attestation, the at least one processing device is further configured to retrieve preset security measurements stored in secure storage of a secure embedded controller of the electronic device, retrieve current firmware component measurements from platform configuration registers (PCRs) of a trusted platform module (TPM) of the electronic device, compare the preset security measurements with the current firmware component measurements, and approve or deny the attestation based on the comparison of the preset security measurements with the current firmware component measurements.

In a third embodiment, a non-transitory machine-readable medium includes instructions that when executed by at least one processor cause an electronic device to perform attestation of the electronic device. To perform the attestation, the instructions further comprise instructions that when executed by the at least one processor cause the electronic device to retrieve preset security measurements stored in secure storage of a secure embedded controller of the electronic device, retrieve current firmware component measurements from platform configuration registers (PCRs) of a trusted platform module (TPM) of the electronic device, compare the preset security measurements with the current firmware component measurements, and approve or deny the attestation based on the comparison of the preset security measurements with the current firmware component measurements.

Any single one or any combination of the following features may be used with the first, second, and/or third embodiments. The preset security measurements can be retrieved by a secure software agent of the electronic device. An entry for each event of a plurality of events can be created, using a Unified Extensible Firmware Interface (UEFI) basic input/output system (BIOS), into an event log, where the event log is available to an operating system of the electronic device during run-time of the electronic device. Measurements values may be regenerated by parsing the event log, values of the current firmware component measurements may be compared with the regenerated measurements values, and the attestation may be approved or denied based on the comparison of the values of the current firmware component measurements with the regenerated measurements values. If there is a mismatch with respect to the comparison of the values of the current firmware component measurements with the regenerated measurements values, or the comparison of the preset security measurements with the current firmware component measurements, a remediation action can be triggered, via the secure software agent, by specifying a compromised boot or a compromised device. The attestation may be performed during a boot process of the electronic device. The secure storage may be a non-volatile storage of a secondary serial peripheral interface (SPI) or one-time-programmable fuses of the secure embedded controller.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device in accordance with this disclosure;

FIG. 2 illustrates an example remote attestation service architecture;

FIG. 3 illustrates an example on-device attestation architecture in accordance with this disclosure;

FIG. 4 illustrates an example on-device attestation process in accordance with this disclosure;

FIG. 5 illustrates an example method for on-device attestation in accordance with this disclosure; and

FIG. 6 illustrates another example method for on-device attestation in accordance with this disclosure.

### DETAILED DESCRIPTION

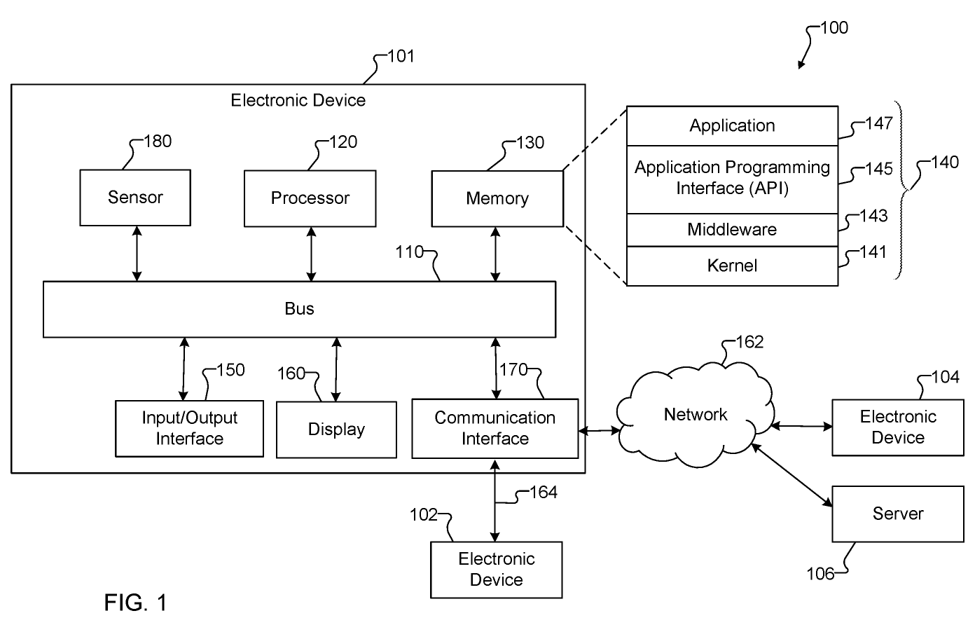

FIGS. 1 through 6, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, with the increasing number of cyber attacks, it is essential to ensure an electronic device is booted without any evidence of tampering. Attestation is one of the processes through which an electronic device’s health can be verified using one or more reference measurements. However, existing attestation techniques have various issues.

For example, there are both existing local and remote attestation methods, but each type has problems. For instance, although local attestation is cheaper because it is run on the device, local attestation can only compare generated platform configuration registers (PCRs) with a unified extensible firmware interface (UEFI) event log that has current PCR values from trusted platform module (TPM) PCRs. Due to lack of secure storage availability (except very limited TPM non-volatile storage), the reference measurements cannot be stored locally, so a local attestation cannot compare the current measurement with reference measurement. Also, if the device is compromised, local attestation may not run at all.

Remote attestation tends to be more secure as remote attestation can be run remotely, reducing the risk of tampering. Also, remote attestation can compare reference measurements stored in remote tamper proof storage with the current device measurements and determine the health of the device more securely. However, remote attestation is expensive, since the target electronic device typically needs to enroll through a third-party mobile device management (MDM) service and a remote verifier provides the attestation service. Due to the cost involved with remote attestation, many original equipment manufacturers (OEMs) and/or customers tend to skip remote attestation, making electronic devices more vulnerable to adversaries. Also, although remote attestation is more secure, reference measurements need to be stored remotely for the verification, and usually the operating system attestation agent serves the purpose of establishing operating system requirements and in many cases is not configurable to meet OEM specific requirements.

To address the above issues, this disclosure provides for on-device attestation architectures and processes/methods that utilize secure storage and one or more secure embedded controllers to securely store reference measurements and to securely access the reference measurements during device attestation. Many electronic devices have an onboard or embedded security controller that has private access to secondary secure storages, and this disclosure utilizes these to perform secure, on-device, attestation. Also, using an advanced configuration and power interface (ACPI), many electronic devices support embedding a persistent security agent into the basic input/output system (BIOS), e.g., UEFI BIOS, which can be launched by the operating system, such as WINDOWS, during the early boot phase, and this disclosure utilizes such persistent security agents in performing on-device attestation.

The emboidments of this disclosure thus provide for an alternative of remote attestation by executing an attestation service on the device itself, while providing the same or similar security levels that remote attestation provides. The on-device embedded controller and persistent security agent are used to achieve this security goal.

For example, various embodiments of this disclosure include performing attestation during a boot process for an electronic device that includes extending firmware component measurements into TPM’s PCRs and having UEFI BIOS create an entry for each event into a UEFI event log which is available to the operating system (OS) during run-time. This disclosure also provides for incorporating the attestation service as a part of the OEM’s persistent and secure agent, where the attestation service launches on-device during early boot of the OS, e.g., during the early launch anti malware (ELAM) phase. This can include, as a part of provisioning, storing the known measurements (otherwise referred to in the industry as the golden measurements) into on-device secure storage, such as secondary serial peripheral interface (SPI)’s non-volatile storage or one-time-programmable (OTP) fuses of the secure embedded controller. In all subsequent boots, the secure agent running on the OS receives the golden measurements from the secure storage through the secure embedded controller, while the secure agent receives current measurements (e.g., current PCR values) from the TPM and regenerates the PCR values by parsing UEFI trusted computing group (TCG) event logs.

Various embodiments of this disclosure can further include comparing the current PCR values with the generated PCR values from the event logs (and potentially any other refence measurements stored into the electronic device’s secure storage). If, based on the comparison of the current PCR values with the generated PCR values from the event logs, there is a match, this indicates an uncompromised boot and regular boot processes can continue. The secure agent can also compare the current measurements with the reference/golden measurements stored in the secure storage, where a match indicates the good health of the electronic device and thus normal boot processes can continue. By running this attestation process on-device and storing the golden measurement on-device, this process removes the need of any remote software or hardware agent. If a mismatch is detected in either the comparison of the current PCR values with the generated PCR values from the event logs or the comparison of the current PCR values with the reference/golden measurements, the secure agent can trigger a remediation action by specifying a compromised boot or a compromised device.

Note that while some of the embodiments discussed below are described in the context of use in consumer electronic devices (such as personal computers), this is merely one example. It will be understood that the principles of this disclosure may be implemented in any number of other suitable contexts and may use any suitable device or devices.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to on-device attestation

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to on-device attestation. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform various operations related to on-device attestation.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

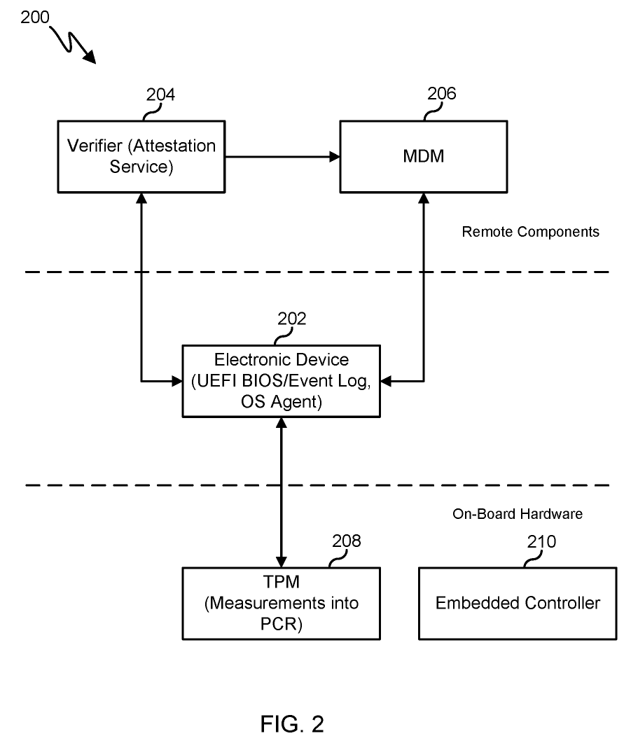

FIG. 2 illustrates an example remote attestation service architecture 200. As shown in FIG. 2, an electronic device 202, such as a PC, is the subject of an attestation process performed by a remote verifier/attestation service 204, that will determine the security health of the electronic device 202. The electronic device 202 may also have an OS agent that communicates with the remote attestation service 204 as well as with a remote MDM 206. The electronic device 202 can be booted, such as by using UEFI BIOS which creates an event log and extends device measurements into TPM 208 of the electronic device 202. The TPM 208 is a tamper proof hardware entity that offers PCRs to extend the measurements (e.g., a hash of the software/firmware) during the boot process.

The MDM 206 is a remote entity that manages devices and controls access to other services by the devices depending on the health of the devices as determined by the remote attestation service 204. As noted above, the remote attestation service 204 determines the health of the electronic device 202 by interacting with the OS agent running on the electronic device 202 and interacting with the MDM 206. In some cases, the remote attestation service 204 can be part of MDM 206.

The electronic device 202 also includes as part of its on-board hardware an embedded security controller 210. However, the embedded controller 210 has no role in the remote attestation process carried out by the attestation service 204. Rather, the embedded security controller 210 is illustrated in FIG. 2 to demonstrate that embedded controllers like the embedded security controller 210 often are included in electronic device hardware, but are not currently utilized in performing attestation.

Although FIG. 2 illustrates one example of a remote attestation service architecture 200, various changes may be made to FIG. 2. For example, for simplicity, it will be understood that various electronic device components that may be included in the electronic device 202 are not illustrated in FIG. 2, and that other remote services or components may also be in communication with the electronic device 202.

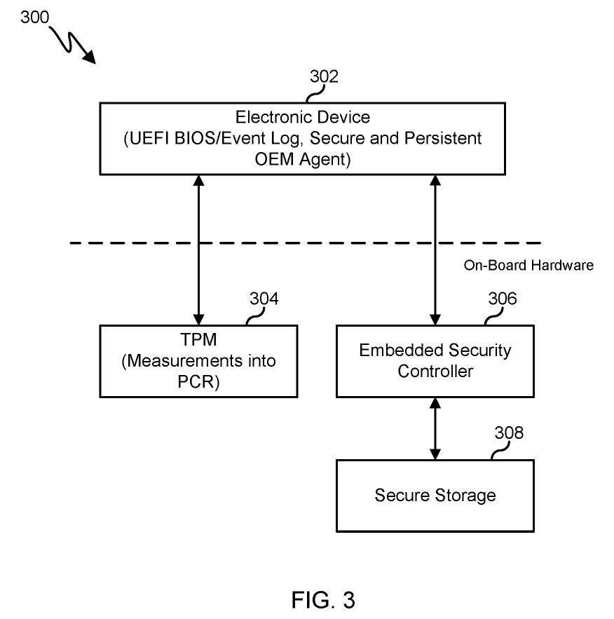

FIG. 3 illustrates an example on-device attestation architecture 300 in accordance with this disclosure. For ease of explanation, the architecture 300 shown in FIG. 3 is described as being implemented on or supported by the electronic device 101 in the network configuration 100 of FIG. 1. However, the architecture 300 shown in FIG. 3 could be used with any other suitable device(s) and in any other suitable system(s).

As shown in FIG. 3, an electronic device 302, e.g., the electronic device 101, can have various system components such as a UEFI BIOS, a UEFI BIOS event log, and a secure and persistent OEM agent. On-board hardware of the electronic device 302 includes a TPM 304, a secure embedded controller 306, and a secondary secure storage 308. As described above, existing attestation processes do not utilize embedded security controllers, like the secure embedded controller 210, 306, nor secure storage accessible to embedded security controllers, like the secure storage 308.

The architecture 300 is used to perform on-device attestation. For example, as a part of a boot process, such as with a UEFI BIOS, after establishing root of trust (ROT), the firmware of the electronic device 302 verifies at least one component by verifying the cryptographic signature of the component(s). At or around the same time, the firmware of the electronic device 302 extends the measurements of each component into the TPM 304’s PCRs, and the electronic device 302, such as via the UEFI BIOS, also creates an entry for each event into an event log which is available to the OS of the electronic device 302 during runtime. The attestation process can be incorporated as part of the OEM’s persistent and secure agent. By incorporating the attestation service as a part of OEM’s persistent and secure agent that will be launched during the early boot phase, the OEM can run attestation on-device rather than remotely.

Further, the architecture 300 is used to store the reference or golden measurement local. For example, as a part of a one-time provisioning process, a reference integrity measurement (RIM) can be stored into the on-device secure storage 308. In various embodiments, the secure storage 308 can be secondary SPI’s non-volatile storage, OTP fuses of the secure embedded controller 306, etc. The secure embedded controller 306 retrieves the golden measurements from the secure storage 308 and provides the golden measurements to the secure agent of the electronic device 302. At or around the same time, the secure agent running on the OS receives current measurements (i.e., current PCR values) from the TPM 304 and regenerates the PCR values by parsing the UEFI TCG event logs. The current PCR values can be compared to one or both of the golden measurements retrieved from secure storage 308, and well as the regenerated PCR values from the event logs. A mismatch of either one indicates that there may be a security issue with the electronic device 302, and attestation may fail. The on-device attestation process of this disclosure thus removes the requirements of any remote hardware or software component, while providing a same level of security assertion that current remote attestation services provide. Additionally, the on-device attestation approach of this disclosure provides OEM specific configuration and measurements verification.

Although FIG. 3 illustrates one example of an on-device attestation architecture 300, various changes may be made to FIG. 3. For example, various components and functions in FIG. 3 may be combined, further subdivided, replicated, or rearranged according to particular needs. Also, one or more additional components and functions may be included if needed or desired.

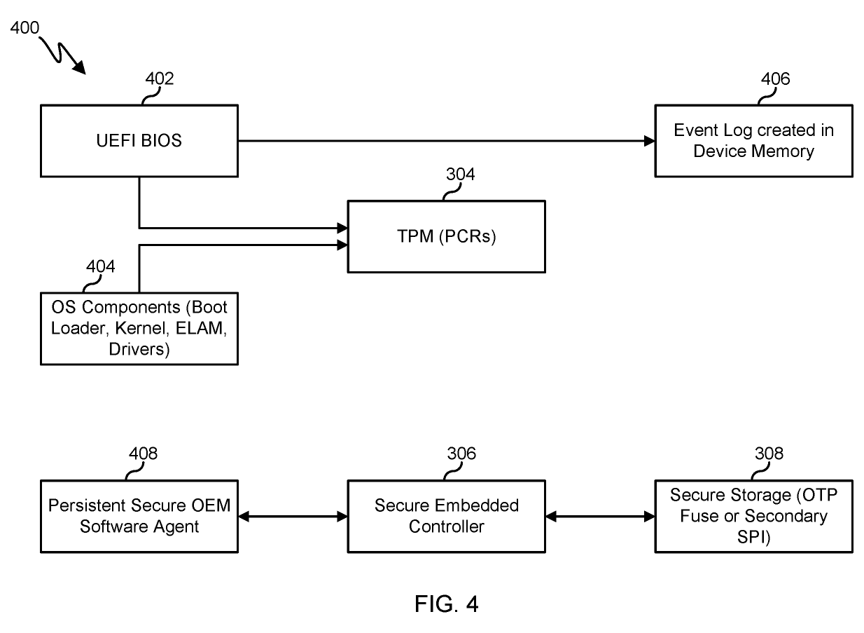

FIG. 4 illustrates an example on-device attestation process 400 in accordance with this disclosure. For ease of explanation, the process 400 is described as involving the use of the electronic device 302 or 101. However, the process 400 may be used with any other suitable electronic device and in any other suitable system(s).

It will be understood that the components illustrated in FIG. 4 are all a part of the electronic device. As shown in FIG. 4, a UEFI BIOS 402 is at least a part of the firmware that is used to boot the electronic device. OS components 404 include various components such as a boot loader, an OS kernel, the ELAM phase programming, and various OS drivers. During boot, the OS components 404 extend device measurements to the TPM 304’s PCRs. Also, while the system boots, an event log 406 is created in device memory, e.g., random access memory (RAM) or another memory or storage of the electronic device, by the UEFI BIOS 402. This event log 406 is later available to the OS, and the event log acts as a journal for TPM PCR extend values. Any TPM extend operation also creates a corresponding event log entry.

As further illustrated in FIG. 4, the process 400 involves use of a secure agent 408, i.e., an OEM persistent secure agent. The secure agent 408 is passed from the UEFI BIOS 402 to the OS side (e.g., by using a Windows Platform Binary Table (WPBT)) and will run during the on-device attestation process 400 to act as a trusted persistent agent to perform the attestation service. The secure embedded controller 306 interacts with the persistent secure agent 408 running on the OS side.

As also shown in FIG. 4, the secure embedded controller 306 has access to the secure storage 308, which, as described in this disclosure, can be a secondary SPI storage or OTP fuses of the secure embedded controller 306, and which can be accessed directly only by the secure embedded controller 306. The secure storage 308 stores the golden measurements securely, since no host can have direct access to the secure storage 308. During the attestation process, two measurement comparisons can be performed: (1) a comparison of the measurements stored in the TPM 304’s PCRs against the measurements regenerated using the event log 406; and (2) a comparison of the preset reference measurements, i.e., the golden measurements, retrieved from secure storage 308 by the secure embedded controller 306 against the measurements stored in the TPM 304’s PCRs.

If either comparison fails, this can indicate that the electronic device has a security issue, e.g., the electronic device has been tampered with or is otherwise compromised. In response to a failure of the attestation process, a remedial action may be triggered. Such remedial actions can include, but are not limited to, (i) a denial of service (DoS), where the device is not allowed to connect to a network, (ii) isolation and quarantine of the device to prevent any further potential threat, (iii) a complete shutdown of the device and to add a critical entry into OS/cloud agent's event log, (iv) reattempting the boot attestation after a soft reset of the device, (v) a self-remediation process, such as initiating a recovery from known firmware/software images, and/or (vi) any predefined policy based action such as denying access to sensitive resources.

The device may also be denied permission to further boot up, and/or be denied access to certain local or remote services due to the possible security risk posed by the compromised electronic device. Of course, if the attestation process succeeds, that is, the comparisons result in matching measurement values, the electronic device can be operated as normal and use any associated local or remote services.

The attestation service of this disclosure is thus performed by the secure agent 408, and the storing of golden measurements will be in the secure storage 308, and both are within the device. Thus, the attention does not use any remote devices or components. Although the attestation is performed locally on-device, by comparing the current PCR values with generated PCR values from event log as well as comparing the current PCR values with the golden measurements stored locally, the attention provides a same or similar security assertion as remote attestation.

Although FIG. 4, illustrates one example of an on-device attestation process 400, various changes may be made to FIG. 4. For example, various components and functions in FIG. 4 may be combined, further subdivided, replicated, or rearranged according to particular needs. Also, one or more additional components and functions may be included if needed or desired.

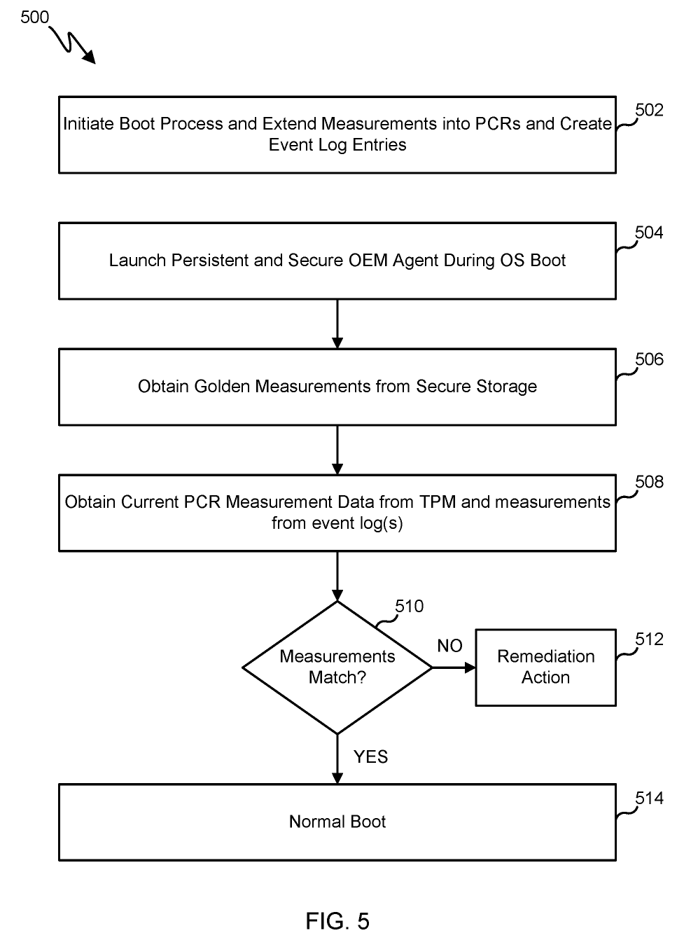

FIG. 5 illustrates an example method 500 for on-device attestation in accordance with this disclosure. For ease of explanation, the method 500 shown in FIG. 5 is described as being performed using the electronic device 302 or 101. However, the method 500 could be performed using any other suitable device(s) and in any other suitable system(s).

At step 502, a boot process is initiated and, when the electronic device is booted, such as with a UEFI BIOS with a TPM, the electronic device automatically extends measurements into TPM’s PCRs and, at the same time, the BIOS creates an entry for each event into an event log which is available to the OS during run-time. At step 504, during the early boot phase of the OS, a persistent and secure OEM agent, such as the secure agent 408, is launched.

At step 506, the reference/golden measurements are obtained from secure storage, such as the secure storage 308, by a secure embedded controller, such as the secure embedded controller 306. As described in this disclosure, as a part of provisioning, the reference or golden measurements are stored into the secured storage, such as either secondary SPI’s non-volatile storage or the embedded controller’s OTP. In all subsequent boots, the secure agent can thus obtain the golden measurements from the secure storage through the secure embedded controller.

At step 508, at or around the same time, the secure agent running in the OS obtains the current PCR measurements from the TPM, and measurements using the event logs by using the attestation service handled by the secure agent to regenerate the PCR values from the event logs. At step 510, it is determined whether the measurements match. This can include a first check involving the comparison of the current PCR values with the generated PCR values from event logs to determine if the measurements match, and a second check of the current PCR values with the golden measurements retrieved from the secure storage using the secure embedded controller. In some embodiments, it is possible for the OEM to configure other measurements as well, and, if that is the case, the attestation service of the secure agent can also use those other measurements in other comparisons.

If, at step 510, it is determined the measurements do not match based on the two comparisons, the secure agent can trigger a remediation action at step 512. The remediation action can include, but is not limited to, (i) a denial of service (DoS), where the device is not allowed to connect to a network, (ii) isolation and quarantine of the device to prevent any further potential threat, (iii) a complete shutdown of the device and to add a critical entry into OS/cloud agent's event log, (iv) reattempting the boot attestation after a soft reset of the device, (v) a self-remediation process, such as initiating a recovery from known firmware/software images, and/or (vi) any predefined policy based action such as denying access to sensitive resources. If, at step 510, it is determined the measurements match, then normal boot can continue at step 514.

Although FIG. 5 illustrates one example of a method 500 for on-device attestation, various changes may be made to FIG. 5. For example, while shown as a series of steps, various steps in FIG. 5 could overlap, occur in parallel, occur in a different order, or occur any number of times (including zero times). For instance, while FIG. 5 refers to the attention service being using during bootup of an electronic device, the attestation process can also be performed as needed after bootup. For example, attestation can also be performed as part of a remote secured service that is being accessed by the electronic device in which a remote device requests for the electronic device to check its authenticity and provide its on-device attestation results to the remote device. As another example, although the method 500 involves comparing both the current measurements with the regenerated event log measurements and the current measurements with the golden measurements, in some emboidments, just one of the comparisons may be performed.

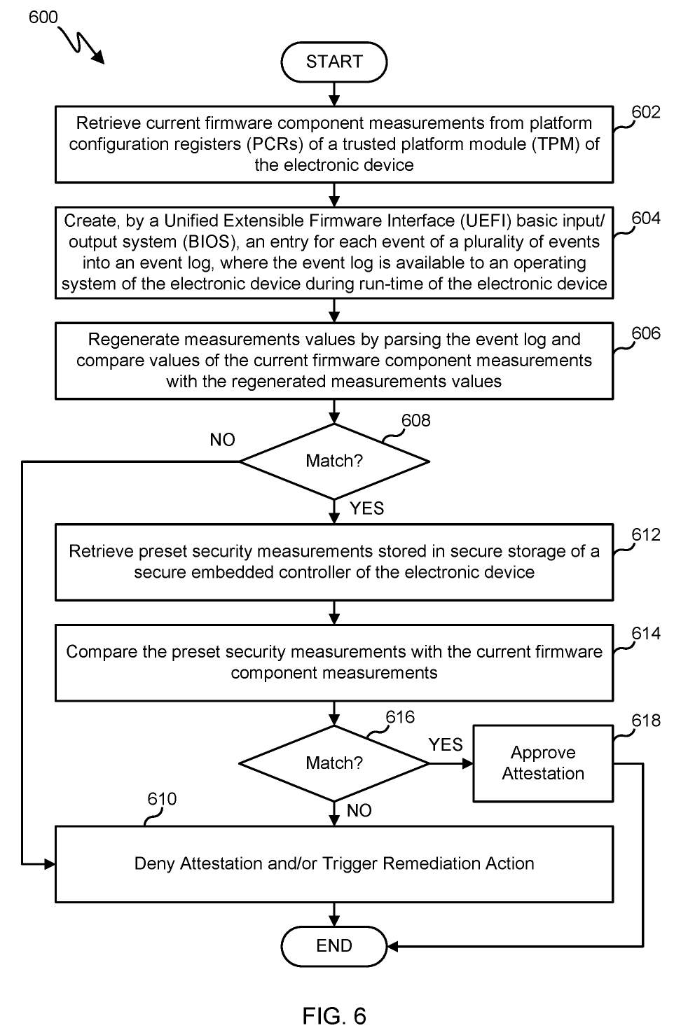

FIG. 6 illustrates another example method 600 for on-device attestation in accordance with this disclosure. For ease of explanation, the method 600 shown in FIG. 6 is described as being performed using the electronic device 302 or 101. However, the method 600 could be performed using any other suitable device(s) and in any other suitable system(s).

As described in this disclosure, the attestation can be performed during a boot process of the electronic device, or during another process as needed when attestation is requested. As also described in this disclosure, the attestation method can be performed using a secure software agent of the electronic device, such as the persistent and secure OEM software agent 408.

At step 602, current firmware component measurements are retrieved, such as from PCRs of a TPM of the electronic device. At step 604, an entry for each event of a plurality of events are created, such as by using a UEFI BIOS, and stored into an event log, where the event log is available to an operating system of the electronic device during run-time of the electronic device.

At step 606, measurements values are regenerated by parsing the event log and values of the current firmware component measurements, previously retrieved at step 602, are compared with the regenerated measurements values. At step 608, it is determined whether the current firmware component measurements and the regenerated measurements values match. If not, the method 600 moves to step 610. At step 610, the attestation is denied and/or one or more remediation actions are triggered by specifying a compromised boot or a compromised device. The remediation actions can include, but are not limited to, (i) a denial of service (DoS), where the device is not allowed to connect to a network, (ii) isolation and quarantine of the device to prevent any further potential threat, (iii) a complete shutdown of the device and to add a critical entry into OS/cloud agent's event log, (iv) reattempting the boot attestation after a soft reset of the device, (v) a self-remediation process, such as initiating a recovery from known firmware/software images, and/or (vi) any predefined policy based action such as denying access to sensitive resources.

If, at step 608, it is determined that the current firmware component measurements and the regenerated measurements values match, the method moves to step 612. At step 612, preset security measurements (e.g., golden measurements) stored in secure storage of a secure embedded controller of the electronic device are retrieved. The secure storage can be the secure storage 308 and the secure embedded controller can be the secure embedded controller 306. As described in this disclosure, in various embodiments, the secure storage can be non-volatile storage of an SPI, or OTP fuses of the secure embedded controller.

At step 614, the preset security measurements are compared with the current firmware component measurements previously retrieved at step 602. At step 616, it is determined whether the current firmware component measurements and the preset security measurements values match. If not, the method 600 moves to step 610. At step 610, the attestation is denied and/or one or more remediation actions are triggered by specifying a compromised boot or a compromised device. If, at step 616, it is determined that the current firmware component measurements and the preset security measurements values match, the method moves to step 618. At step 618, the on-device attestation is approved, and the electronic device can continue with normal operations.

Although FIG. 6 illustrates one example of a method 600 for on-device attestation, various changes may be made to FIG. 6. For example, while shown as a series of steps, various steps in FIG. 6 could overlap, occur in parallel, occur in a different order, or occur any number of times (including zero times). For instance, although the method 600 involves comparing both the current measurements with the regenerated event log measurements and the current measurements with the preset security measurements, in some emboidments, just one of the comparisons may be performed.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
performing attestation of an electronic device, including:
retrieving preset security measurements stored in secure storage of a secure embedded controller of the electronic device; retrieving current firmware component measurements from platform configuration registers (PCRs) of a trusted platform module (TPM) of the electronic device; comparing the preset security measurements with the current firmware component measurements; and approving or denying the attestation based on the comparison of the preset security measurements with the current firmware component measurements.

2. The method of claim 1, wherein the preset security measurements are retrieved by a secure software agent of the electronic device.

3. The method of claim 2, further comprising creating, using a Unified Extensible Firmware Interface (UEFI) basic input/output system (BIOS), an entry for each event of a plurality of events into an event log, wherein the event log is available to an operating system of the electronic device during run-time of the electronic device.

4. The method of claim 3, further comprising:
regenerating measurements values by parsing the event log;
comparing values of the current firmware component measurements with the regenerated measurements values; and
approving or denying the attestation based on the comparison of the values of the current firmware component measurements with the regenerated measurements values.

5. The method of claim 4, further comprising, if there is a mismatch with respect to the comparison of the values of the current firmware component measurements with the regenerated measurements values, or the comparison of the preset security measurements with the current firmware component measurements, triggering, via the secure software agent, a remediation action by specifying a compromised boot or a compromised device.

6. The method of claim 1, wherein the attestation is performed during a boot process of the electronic device.

7. The method of claim 1, wherein the secure storage is non-volatile storage of a secondary serial peripheral interface (SPI) or one-time-programmable fuses of the secure embedded controller.

8. An electronic device comprising:
at least one processing device configured to perform attestation of the electronic device, wherein the at least one processing device is further configured to:
retrieve preset security measurements stored in secure storage of a secure embedded controller of the electronic device; retrieve current firmware component measurements from platform configuration registers (PCRs) of a trusted platform module (TPM) of the electronic device; compare the preset security measurements with the current firmware component measurements; and approve or deny the attestation based on the comparison of the preset security measurements with the current firmware component measurements.

9. The electronic device of claim 8, wherein the preset security measurements are retrieved by a secure software agent of the electronic device.

10. The electronic device of claim 9, wherein the at least one processing device is further configured to create, using a Unified Extensible Firmware Interface (UEFI) basic input/output system (BIOS), an entry for each event of a plurality of events into an event log, wherein the event log is available to an operating system of the electronic device during run-time of the electronic device.

11. The electronic device of claim 10, wherein the at least one processing device is further configured to:
regenerate measurements values by parsing the event log; compare values of the current firmware component measurements with the regenerated measurements values; and approve or deny the attestation based on the comparison of the values of the current firmware component measurements with the regenerated measurements values.

12. The electronic device of claim 11, wherein the at least one processing device is further configured to, if there is a mismatch with respect to the comparison of the values of the current firmware component measurements with the regenerated measurements values, or the comparison of the preset security measurements with the current firmware component measurements, trigger, via the secure software agent, a remediation action by specifying a compromised boot or a compromised device.

13. The electronic device of claim 8, wherein the attestation is performed during a boot process of the electronic device.

14. The electronic device of claim 8, wherein the secure storage is non-volatile storage of a secondary serial peripheral interface (SPI) or one-time-programmable fuses of the secure embedded controller.

15. A non-transitory machine-readable medium comprising instructions that when executed by at least one processor cause an electronic device to:
perform attestation of the electronic device, wherein, to perform the attestation, the instructions further comprise instructions that when executed by the at least one processor cause the electronic device to:
retrieve preset security measurements stored in secure storage of a secure embedded controller of the electronic device; retrieve current firmware component measurements from platform configuration registers (PCRs) of a trusted platform module (TPM) of the electronic device; compare the preset security measurements with the current firmware component measurements; and approve or deny the attestation based on the comparison of the preset security measurements with the current firmware component measurements.

16. The non-transitory machine-readable medium of claim 15, wherein the preset security measurements are retrieved by a secure software agent of the electronic device.

17. The non-transitory machine-readable medium of claim 16, wherein the instructions further comprise instructions that when executed by the at least one processor cause the electronic device to create, using a Unified Extensible Firmware Interface (UEFI) basic input/output system (BIOS), an entry for each event of a plurality of events into an event log, wherein the event log is available to an operating system of the electronic device during run-time of the electronic device.

18. The non-transitory machine-readable medium of claim 17, wherein the instructions further comprise instructions that when executed by the at least one processor cause the electronic device to:
regenerate measurements values by parsing the event log; compare values of the current firmware component measurements with the regenerated measurements values; and approve or deny the attestation based on the comparison of the values of the current firmware component measurements with the regenerated measurements values.

19. The non-transitory machine-readable medium of claim 18, wherein the instructions further comprise instructions that when executed by the at least one processor cause the electronic device to, if there is a mismatch with respect to the comparison of the values of the current firmware component measurements with the regenerated measurements values, or the comparison of the preset security measurements with the current firmware component measurements, trigger, via the secure software agent, a remediation action by specifying a compromised boot or a compromised device.

20. The non-transitory machine-readable medium of claim 15, wherein the secure storage is non-volatile storage of a secondary serial peripheral interface (SPI) or one-time-programmable fuses of the secure embedded controller.
